(19) United States
(12) Patent Application Publication
(10) Pub. No.: US 2026/0284645 A1
(43) Pub. Date: Sep. 24, 2026

(54) FLUIDIZED CATALYTIC CRACKING CATALYST AND METHODS OF MAKING AND USING THE SAME

(71) Applicant: Ketjen Limited Liability Company, Houston, TX (US)

(72) Inventors: Min Li, Houston, TX (US); Edward Lee Foster, Pearland, TX (US); Bethzaely Fernandez-Reyes, Pearland, TX (US); Nataly Garcia Vargas, Pearland, TX (US); Shane Adam Bates, Houston, TX (US)

(73) Assignee: Ketjen Limited Liability Company, Houston, TX (US)

(21) Appl. No.: 19/082,419

(22) Filed: Mar. 18, 2025

(51) Int. Cl. B01J 29/08; B01J 37/00; B01J 37/12; C10G 11/18

(52) U.S. Cl. CPC B01J 29/084; B01J 37/0045; B01J 37/12; C10G 11/18; C10G 2300/70

(57) ABSTRACT

Processes for preparing a catalyst is provided that includes addition of a phosphorous containing component at one or more points are provided herein. The resulting catalysts are suitable for use in a fluidized catalytic cracker (FCC) or other similar chemical processing unit. Processes according to embodiments of the present technology are suitable for use in existing and commercial-scale facilities, and may result in reduced expense, while providing energy-saving and environmental benefits.

### FIELD OF THE INVENTION

This invention generally relates to methods for preparing catalysts, as well as the catalysts obtainable by such methods, as well as methods for using the same. In particular, the present invention relates to catalysts suitable for use in fluidized catalytic cracking (FCC) processes and systems.

### BACKGROUND

A common challenge in the design and production of heterogeneous catalysts is to find a good compromise between the effectiveness and/or accessibility of the active sites and the effectiveness of the immobilizing matrix in giving the catalyst particles sufficient physical strength, i.e. attrition resistance. In general, these types of catalysts, which may be suitable for use as, for example, fluidized catalytic cracking (FCC) catalyst, can be prepared by forming an aqueous slurry including a zeolite and other active and inactive components, followed by spray drying or other form of shaping to produce a plurality of catalytic particles. To date, modifications of the zeolites and other components and changes to the overall process steps and conditions have been attempted in an effort to maximize production efficiency and catalyst performance. Although improvements have been achieved, a need still exists for improved catalysts with even better performance and properties that can be produced efficiently on a large-scale while also minimizing capital and operating costs.

### SUMMARY

In some aspects of the present technology, there is provided a process for preparing a catalyst comprising: (a) providing at least an amount of a zeolite, an amount of a silica source, an amount of an alumina source, and an amount of clay; (b) combining at least a portion of the zeolite, the silica source, the alumina source, and the clay with a liquid to form a slurry; (c) adding a monovalent acid to the slurry to provide an acid-modified slurry; (d) optionally adjusting the pH of the acid-modified slurry to provide a pH-adjusted slurry having a pH of at least 3; (e) shaping at least a portion of the acid modified slurry or pH-adjusted slurry, when present, to form a plurality of catalytic particles; and (f) during at least a portion of steps (a) through (e), adding a phosphorous containing compound to at least one of the zeolite, the slurry, the acid-modified slurry, and the pH-adjusted slurry.

In some aspects of the present technology, there is provided a fluidized catalytic cracking (FCC) catalyst formed by such a process.

In some aspects of the present technology, there is provided a process for treating a hydrocarbon-containing feedstock comprising contacting the hydrocarbon-containing feedstock with a catalyst formed by such a process to provide one or more treated hydrocarbon streams.

### DETAILED DESCRIPTION

According to embodiments of the present technology, an improved process for producing a catalyst is provided that includes addition of at least one phosphorous containing component. In general, the process comprises the steps of: (a) providing at least an amount of zeolite, an amount of a silica source, an amount of an alumina source, and an amount of clay; (b) combining at least a portion of the zeolite, the silica source, the alumina source, and the clay with a liquid to form a slurry; (c) adding a monovalent acid to the slurry to provide an acid-modified slurry; (d) optionally adjusting the pH of the acid-modified slurry to provide a pH-adjusted slurry; (e) shaping at least a portion of the acid-modified slurry or pH-adjusted slurry, when present, to form a plurality of catalytic particles; and (f) during at least a portion of step (a) through (e), adding a phosphorous containing compound to at least one of the zeolite, the slurry, the acid-modified slurry, and the pH-adjusted slurry. In some aspects, catalysts formed from processes according to embodiments of the present technology exhibit desirable properties, including enhanced activity, particle strength/integrity, and/or attrition resistance, while also being economical to produce as compared to similar conventional catalysts. Additionally, there may be energy-saving benefits and/or positive environmental impacts of processes as described herein, as compared to conventional processes for preparing similar materials.

According to embodiments of the present technology, at least one phosphorous containing component may be added to the catalyst formation process at one or more, two or more, or three or more points (or times) during the overall process. In some cases, at least a portion of the phosphorous containing component may be added to the zeolite (or a slurry comprising the zeolite) as part of (or prior to) the providing of step (a), such that a phosphorous-modified zeolite may be used to form the slurry in step (b). When a phosphorous-modified zeolite is used to form the slurry in step (b), it may be added with or without additional zeolite that has not been modified with a phosphorous containing component (i.e., an unmodified zeolite).

When a phosphorous-modified zeolite is added to the slurry of step (b), one or more zeolites not modified with phosphorous may also be added. The unmodified zeolite may be the same as or different than the phosphorous-modified zeolite. When modified and unmodified zeolites are used, each may be added separately, or both may be added together during the combining of step (b).

Alternatively, or in addition, at least a portion of the phosphorous containing component may be added to the slurry during at least a portion of step (b). When added to the slurry, the phosphorous containing component may be added before (all or a portion of) the zeolite, simultaneously with (all or a portion of) the zeolite, and/or after (all or a portion of) the zeolite. Similarly, the phosphorous containing component may be added before, with, and/or after all or a part of one or more of the other slurry components.

Alternatively, or in addition, at least a portion of the phosphorous containing component may be added to the slurry after all of the other components have been added but prior to addition of a monovalent acid. In some embodiments, at least a portion of the phosphorous containing component may be added simultaneously with and/or after addition of the monovalent acid in step (c) and/or just prior to the pH adjustment of step (d), when performed. Alternatively, or in addition, at least a portion of the phosphorous containing component may be added as part of the pH adjustment of step (d), when performed, and/or immediately subsequent to it but prior to the shaping of step (e). In some cases, the phosphorous containing component may be added after the monovalent acid (or pH adjusting step, when performed) but not more than 30 minutes, not more than about 15 minutes, not more than about 10 minutes, or not more than about 5 minutes prior to the shaping of step (e).

According to some embodiments, the phosphorous containing component may be added at multiple points during the process. For example, a portion may be added prior to the preparation of the slurry of step (b) and a portion may be added after formation of the acid-modified slurry of step (c), but before the pH adjustment step. Alternatively, or in addition, a portion of the phosphorous containing component may be added at the beginning of the slurry preparation step and a portion may be added in the middle and/or end of that step. In other embodiments, at least a portion of the phosphorous containing component may be added to the zeolite to provide a modified zeolite, and a portion of the phosphorous containing component may be added (with the modified zeolite) to the other components in order to form the slurry in step (b). In some embodiments, a portion of the phosphorous containing component may be added to the zeolite before or during the providing of step (a) and a portion may be added just prior to the shaping of step (e). In some embodiments, portions of the phosphorous containing component may be added at different times during the same step, such as at or near the beginning and at or near the end of a step, such as the slurry formation of step (b) or the acid modification of step (c).

In other embodiments, the phosphorous containing component may only be added to the process at one point such as, for example, as part of or prior to the providing of step (a), after the acid modification of step (c), prior to preparing the slurry in step (b), during the slurry preparation of step (b), or immediately prior to the forming of step (e). The specific point or points at which the phosphorous containing component is added may be easily determined by one skilled in the art and may depend on the desired properties of the resulting catalyst, the physical configuration of the process facility, and other similar factors.

Regardless of the specific point or points of the process at which the phosphorus containing component is added, the final phosphorous content in the catalyst formed as described herein may be in the range of from about 0.01 to about 30 weight percent, about 0.05 to about 15 weight percent, about 0.1 to about 20 weight percent, or about 0.1 to about 8.5 weight percent, based on the total dry weight of the catalyst taken as 100 percent. Total phosphorous content is measured as P2O5 content. When the phosphorous containing component is added to the zeolite prior to formation of the slurry, the resulting modified zeolite may comprise similar phosphorous contents, based on the total weight of dry zeolite taken as 100 percent.

In some embodiments, the phosphorous containing compound may comprise any suitable phosphorous containing compound, including those with a covalent or ionic constituent capable of reacting with a hydrogen ion. Examples include phosphoric acid and its salts such as ammonium dihydrogen phosphate and diammonium hydrogen phosphate, ammonium hypophosphate, ammonium orthophosphate, ammonium dihydrogen orthophosphate, ammonium hydrogen orthophosphate, triammonium phosphate, phosphines, and phosphites. Suitable phosphorus-containing compounds include derivatives of groups represented by PX₃, RPX₂, R₂PX, R1P, R₃P═O, RPO₂, RPO(OX)₂, PO(OX)₃, R₂P(O)OX, RP(OX)₂, ROP(OX)₂, and (RO)₂POP(OR)₂, wherein R is an alkyl or phenyl radical and X is hydrogen, R or halide. These compounds include primary, RPH₂, secondary, R₂PH, and tertiary, R₃P, phosphines such as butyl phosphine; tertiary phosphine oxides, R₃PO, such as tributyl phosphine; primary, RP(O)(OX)₂, and secondary, R₂P(O)OX, phosphonic acids such as benzene phosphonic acid; esters of the phosphonic acids such as diethyl phosphonate, (RO)₂P(O)H, dialkyl phosphinates, (RO)P(O)R₂; phosphinous acids, R₂PDX, such as diethylphosphinous acid, primary, (RO)P(OX)₂, secondary, (RO)₂PDX, and tertiary, (RO)₃P, phosphites; and esters thereof such as monopropyl ester, alkyldialkyl phosphinites, (RO)P₂, and dialkyl phosphonite, (RO)₂PR esters. Examples of phosphite esters include trimethyl phosphite, triethyl phosphite, diisopropyl phosphite, butyl phosphite; and pyrophosphites such as tetrapyrophosphite. The alkyl groups in the mentioned compounds contain 1 to 4 carbon atoms. Other suitable phosphorus-containing compounds include phosphorus halides such as phosphorus trichloride, bromide, and iodide, alkyl phosphorodichloridites, (RO)PCl₂, dialkyl phosphorochloridites, (RO)₂PCl, alkyl phosphonochloridates, (RO)(R)P(O)Cl, and dialkyl phosphinochloridates, R₂P(O)Cl. In a preferred embodiment, the phosphorous containing component comprises phosphoric acid.

In some embodiments, the zeolite provided in step (a) can comprise one or more chosen from Y zeolites, zeolite beta, ZSM-5, phosphorous activated ZSM-5, ion-exchanged ZSM-5, MCM-22, MCM-36, metal-exchanged zeolites, ITQs, SAPOs, ALPOs, and mixtures thereof. In a preferred embodiment, the zeolite comprises a Y-zeolite. Examples of suitable Y zeolites include, but are not limited to, HY, USY, dealuminated Y, RE-Y, and RE-USY. When used, the Y zeolite may comprise one or more of these types of zeolites. In some embodiments, the zeolite may have a low sodium content, such as, for example, less than 1.5 wt %, less than about 1.0 wt %, less than about 0.5 wt %, or less than about 0.1 wt % Na₂O, or it may be free of sodium.

In some embodiments, the silica source provided in step (a) can comprise a source of silica in a suitably dispersed form. Examples include, but are not limited to, silica hydrosol, silica gel, silica col, and silicic acid. In some cases, the source of silica comprises an aqueous colloidal dispersion of silica particles. Suitable silica sols may be derived from an ion-exchange process and can have a substantially uniform particle size within the range of about 10 to about 400 Angstroms.

In some embodiments, the silica source can comprise a sodium-free silica source. Examples include, but are not limited to, (poly)silicic acid, sodium-free silica sol, potassium silicate, lithium silicate, calcium silicate, magnesium silicate, barium silicate, strontium silicate, zinc silicate, phosphorus silicate, and barium silicate. Examples of suitable organic silicates are silicones (polyorganosiloxanes such as polymethylphenylsiloxane and polydimethylsiloxane) and other compounds containing Si—O—C—O—Si structures, and precursors thereof such as methyl chlorosilane, dimethyl chlorosilane, trimethyl chlorosilane, and mixtures thereof. In preferred embodiments, the silica source can comprise at least one chosen from (poly)silicic acid or sodium-free silica sol. In some cases, one or more of the above can be combined and the mixture may be provided as a silica source in step (a).

The alumina source provided in step (a) may comprise an amorphous alumina or a pseudo-boehmite alumina as typically used in FCC catalyst applications. As used herein, the term “boehmite” is used to describe alumina hydrates which exhibit X-ray diffraction (XRD) patterns close to that of aluminum oxide-hydroxide [AlO(OH)]. The term “boehmite” encompasses wide range of alumina hydrates which contain different amounts of water of hydration, have different surface areas, pore volumes, specific densities, and exhibit different thermal characteristics upon thermal treatment. However, the XRD patterns, although they exhibit the characteristic boehmite [AlO(OH)] peaks, usually exhibit variable widths and may have a slightly shifted location. The sharpness and location of the XRD peaks has been used to indicate the degree of crystallinity, crystal size, and amount of imperfections.

Broadly, there are two categories of boehmite alumina: quasi-crystalline boehmites (QCBs) and micro-crystalline boehmites (MCBs). Quasi-crystalline boehmites may also be referred to herein as pseudo-boehmites and gelatinous boehmites. Usually, these QCBs have higher surface areas, larger pores and pore volumes, and lower specific densities than MCBs. QCBs disperse easily in water or acids, have smaller crystal sizes than MCBs, and contain a larger number of water molecules of hydration. The extent of hydration of QCB can have a wide range of values, for example from about 1.4 up to about 2 moles of water per mole of Al, intercalated usually orderly or otherwise between the octahedral layers. DTG (differential thermogravimetry) indicates that the major amount of water is released from QCBs at a much lower temperature than from MCBs. The XRD patterns of QCBs have broad peaks and the half-widths (i.e. the widths of the peaks at half-maximum intensity) are indicative of the crystal sizes as well as degree of crystal perfection. Some typical commercially available QCBs are PURAL and CAPATAL products (commercially available from Sasol) and VERSAL products (commercially available from UOP).

Microcrystalline boehmites are distinguished from the QCBs by their high degree of crystallinity, relatively large crystal size, very low surface areas, and high densities. Unlike QCBs, MCBs show XRD patterns with higher peak intensities and very narrow half-widths. This is due to their relatively small number of intercalated water molecules, large crystal sizes, the higher degree of crystallization of the bulk material, and the smaller amount of crystal imperfections. Typically, the number of water molecules intercalated can vary in the range from about 1 up to about 1.4 per mole of Al. A typical commercially available MCB is P-200® (commercially available from Condea).

MCBs and QCBs are characterized by powder X-ray reflections. The ICDD contains entries for boehmite and confirms that reflections corresponding to the (020), (021), and (041) planes would be present. For copper radiation, such reflections would appear at 14, 28, and 38 degrees 2-theta. The exact position of the reflections depends on the extent of crystallinity and the amount of water intercalated: as the amount of intercalated water increases, the (020) reflection moves to lower values, corresponding to greater d-spacings. Nevertheless, lines close to the above positions would be indicative of the presence of one or more types of boehmite phases. For the purposes of this description, quasi-crystalline boehmites are defined as having a (020) reflection with a full width at half height (FWHH) of 1.5° or greater than 1.5 2θ. Boehmites having a (020) reflection with a FWHH of smaller than 1.5 2θ are considered micro-crystalline boehmites. Overall, the basic, characteristic differences between QCBs and MCBs involve variations in the following: 3-dimensional lattice order, sizes of the crystallites, amount of water intercalated between the octahedral layers, and degree of crystal imperfections.

In some embodiments, the clay provided in step (a) above may be chosen from one or more of kaolin, bentonite, saponite, sepiolite, attapulgite, laponite, hectorite, English clay, anionic clays such as hydrotalcite, and heat-or chemically treated clays such as meta-kaolin. In a preferred embodiment, the clay may comprise kaolin. In some cases, the clay may also comprise low sodium clay such that the total sodium content can be less than about 0.5 wt %, less than about 0.1 wt %, or less than about 0.05 wt % Na₂O or it may be sodium free.

Additionally, in some embodiments, one or more additional components may also be provided in step (a). Examples of such components can include, but are not limited to, aluminum chlorohydrol, aluminum nitrate, Al2O3, Al(OH)3, anionic clays (e.g. hydrotalcite), smectites, sepiolite, barium titanate, calcium titanate, calcium-silicates, magnesium-silicates, magnesium titanate, mixed metal oxides, layered hydroxy salts, additional zeolites, magnesium oxide, bases or salts, and/or metal additives such as compounds containing an alkaline earth metal (for instance Mg, Ca, and Ba), a Group IIIA transition metal, a Group IVA transition metal (e.g. Ti, Zr), a Group VA transition metal (e.g. V, Nb), a Group VIA transition metal (e.g. Cr, Mo, W), a Group VIIA transition metal (e.g. Mn), a Group VIIIA transition metal (e.g. Fe, Co, Ni, Ru, Rh, Pd, Pt), a Group IB transition metal (e.g. Cu), a Group IIB transition metal (e.g. Zn), a lanthanide (e.g. La, Ce), or mixtures thereof.

As discussed supra, the zeolite, silica source, alumina source, clay, and one or more optional components may be combined with water (or other aqueous liquid) to form a slurry. In some cases, some (or all) of the components may be combined with water as a dry solid, while, in other embodiments, some (or all) of the components may be formed into individual slurries with water (or other liquid) and then combined to form the slurry of step (b). In some cases, a portion of the components may be added as dry solids, while another portion is added as individual slurries.

Any order of addition of these components may be used and, in some cases, it is possible to combine all of these components at one time. Any suitable equipment may be employed to form the slurry, such as, for example, a stirred reactor or other vessel. The total solids content of the slurry formed in step (b) may be in the range of from about 5 to about 45 weight percent, about 10 to about 35 weight percent, about 15 to about 30 weight percent, or about 15 to about 25 weight percent.

In some embodiments, the slurry formed in step (b) may comprise zeolite in an amount of from about 5 to about 75 weight percent, about 10 to about 70 weight percent, about 15 to about 50 weight percent, or about 15 to about 40 weight percent zeolite. Additionally, or in the alternative, the slurry may comprise silica (or silica containing components) in an amount of from about 0.5 to about 45 weight percent, about 1 to about 40 weight percent, about 2 to about 35 weight percent, or about 2.5 to about 20 weight percent. Further, the slurry may comprise alumina (or alumina containing components) in an amount of from about 0.5 to about 75 weight percent, about 1 to about 65 weight percent, about 2 to about 50 weight percent, or about 5 to about 50 weight percent. The clay may be present in the slurry in an amount of from about 1 to about 80 weight percent, about 2.5 to about 75 weight percent, about 5 to about 70 weight percent, about 10 to about 60 weight percent, or about 10 to about 50 weight percent. All percentages referred to in this paragraph are based on dry solids content and are calculated as oxides.

After formation of the slurry in step (b), a monovalent acid may be added to the suspension, causing digestion of at least a portion of the slurry contents. Any suitable monovalent acid may be used and it may be, for example, an organic or inorganic acid. Examples of suitable monovalent acids include, but are not limited to, formic acid, acetic acid, propionic acid, nitric acid, and hydrochloric acid.

In some embodiments, the monovalent acid may be added to the slurry in an amount sufficient to reduce the pH of the slurry to less than about 7, less than about 6, less than about 5, or from about 2 to about 5, or about 2.5 to about 4.5 or about 3 to about 4. As the acid is added to the slurry, it may be agitated by, for example, a stirrer, a grinder, a mill, a high-shear mixer, and/or via ultrasonic waves.

If the pH of the resulting acid-treated slurry is less than about 3, a pH adjustment step may be performed to increase the pH of the slurry to at least about 3, at least about 3.5, at least about 4, at least about 4.5, or at least about 5. The slurry may still be preferably acidic and may have a pH of not more than about 7, not more than about 6.5, not more than about 6, or not more than about 5.5. Slurries with a pH higher than 7 may be more difficult to handle throughout the remainder of the process. When performed, such a pH adjusting step may include addition of at least one base (e.g., sodium hydroxide, potassium hydroxide, and/or ammonium hydroxide) to the acid-modified slurry to provide a pH-adjusted slurry with a pH within the above range. If the pH of the acid-modified slurry formed in step (c) is 3 or higher, such a pH adjusting step may be omitted.

The acid-modified slurry (or pH-adjusted slurry as appropriate) may then be shaped using one or more suitable shaping methods to form a plurality of particles. In some embodiments, the shaping step can be performed nearly immediately after the addition of the acid in step (c) (or the pH adjusting step (d), when needed). For example, the total time between the acid addition in step (c) and/or the pH adjusting of step (d), when used, and the shaping step can be 30 minutes or less, 5 minutes or less, or less than 3 minutes.

Suitable shaping methods can include, but are not limited to, spray drying, pulse drying, pelletizing, extrusion (optionally combined with kneading), beading, or any other conventional shaping method used in the catalyst and absorbent art. In some embodiments, the preferred shaping method is spray drying. When used, the spray drying step may include an inlet temperature of about 300° C. to about 600° C. and the outlet temperature may be from about 105° C. to 200° C. Optionally, the spray dried particles may be calcined. When calcined, the particles can be exposed to an average calcining temperature can be between about 150° C. and 800° C., about 200° C. and 750° C., or about 250° C. and 700° C.

The catalyst obtained according to embodiments of the present technology may comprise zeolite, silica, alumina, and clay. Preferably, such a catalyst comprises zeolite in an amount of from about 5 to about 50 weight percent, or about 7.5 to about 45 weight percent; silica in an amount of from about 0.5 to about 35 weight percent, or about 1 to about 25 weight percent; alumina in an amount of from about 1 to about 50 weight percent, or about 3 to about 40 weight percent; and the balance clay.

Catalysts formed according to embodiments of the present technology can be used as FCC catalysts, as FCC additives—such as SOx reduction additives, NOx reduction additives, CO combustion additives, ZSM-5 additive, or sulfur reduction additives—as well as in hydroprocessing catalysts, alkylation catalysts, reforming catalysts, gas-to-liquid conversion catalysts, coal conversion catalysts, hydrogen manufacturing catalysts, and automotive catalysts.

Embodiments of the present technology further relate to the use of such catalysts as a catalyst or additive in a fluid catalytic cracking, hydroprocessing, alkylation, reforming, gas-to-liquid conversion, coal conversion, and hydrogen manufacturing process, and/or as an automotive catalyst.

Catalysts formed according to embodiments of the present technology are particularly suited for use in a Fluidized Catalytic Cracking (FCC) process. In the FCC process, the details of which are generally known to a skilled artisan, the catalyst comprises a powder having an average particle size such that at least about 90 weight percent of the particles have a diameter in the range of about 5 to about 300 microns. In the reactor portion of the FCC unit, a hydrocarbon feedstock (e.g., gas oil, resid, or other such heavy hydrocarbon stream) is gasified and directed upward through a reaction zone, such that the particulate catalyst is entrained and fluidized in the hydrocarbon feedstock stream. Hot catalyst, which is coming from the regenerator, reacts with the vaporized hydrocarbon feed contacts the catalyst thereby reducing the molecular weight of (e.g., “cracking”) at least a portion of the hydrocarbon components therein. Typically, temperatures in the reactor range from about 400° to about 650° C. with a pressure under, at, or above atmospheric.

Other processes for which catalysts produced as described herein may be utilized may comprise fixed bed, moving bed, and/or fluidized bed catalytic processes, and the feed may travel co-current or counter-currently to the catalyst and/or other fluids passing through the catalyst bed. Catalysts formed according to embodiments of the present technology are also suitable for use in a TCC (Thermofor catalytic cracking), high-severity fluidized catalytic cracking (HS-FCC) and/or deep catalytic cracking (DCC) process.

### DEFINITIONS

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

What is claimed is

1. A process for preparing a catalyst, the process comprising:
(a) providing at least an amount of a zeolite, an amount of a silica source, an amount of an alumina source, and an amount of clay;
(b) combining at least a portion of the zeolite, the silica source, the alumina source, and the clay with a liquid to form a slurry;
(c) adding a monovalent acid to the slurry to provide an acid-modified slurry;
(d) optionally adjusting the pH of the acid-modified slurry to provide a pH-adjusted slurry having a pH of at least 3;
(e) shaping at least a portion of the acid modified slurry or pH adjusted slurry, when present, to form a plurality of catalytic particles; and
(f) during at least a portion of steps (a) through (e), adding a phosphorous containing compound to at least one of the zeolite, the slurry, the acid-modified slurry, and the pH-adjusted slurry.

2. The process of claim 1, wherein at least a portion of the phosphorous containing compound is added after the monovalent acid has been added but before the pH adjusting of step (d), when performed, or before the shaping of step (e) when no pH adjusting of step (d) is performed.

3. The process of claim 1, wherein at least a portion of the phosphorous containing compound is added to the acid-modified slurry or pH-adjusted slurry before the shaping of step (e).

4. The process of claim 3, wherein the phosphorous containing compound is added to the acid-modified slurry or pH-adjusted slurry not more than 30 minutes before the shaping of step (e).

5. The process of claim 1, wherein the process includes the pH adjusting of step (d) and at least a portion of the phosphorous containing component is added during step (d).

6. The process of claim 5, wherein the pH adjusting of step (d) includes adding a base to the acid-modified slurry to provide a pH-adjusted slurry having a pH in the range of from about 4 to about 7.

7. The process of claim 1, wherein at least a portion of the phosphorous containing compound is added to the zeolite provided in step (a) to provide a phosphorous-modified zeolite, and wherein step (b) includes combining at least a portion of the phosphorous-modified zeolite with the liquid to form the slurry.

8. The process of claim 7, wherein the phosphorous-modified zeolite has a P2O5 content in the range of from about 0.5 to about 50 weight percent, based on the total weight of the phosphorous-modified zeolite taken as 100 percent.

9. The process of claim 7, wherein the combining of step (b) further comprises adding a zeolite not modified with the phosphorous containing component to the slurry.

10. The process of claim 1, wherein at least a portion of the phosphorous containing compound is added to the slurry during (b).

11. The process of claim 1, wherein during step (c) at least a portion of the phosphorous containing compound is added before at least a portion of the monovalent acid.

12. The process of claim 11, wherein during step (c) at least a portion of the phosphorous containing compound is added to the slurry after at least a portion of the monovalent acid has been added.

13. The process of claim 1, wherein the phosphorous containing compound comprises phosphoric acid.

14. The process of claim 1, wherein the phosphorous containing compound is added at two or more different points during steps (a) through (e).

15. The process of claim 1, wherein the shaping of step (e) comprises spray drying at least a portion of the acid-modified slurry or the pH-adjusted slurry, when present, to form the catalytic particles.

16. The process of claim 1, further comprising after the shaping of step (e), calcining at least a portion of the catalytic particles to form calcined particles.

17. The process of claim 1, wherein the slurry formed in step (b) comprises zeolite in an amount of from about 5 to about 75 weight percent, silica in an amount of from about 0.5 to 45 weight percent, alumina in an amount of from about 0.5 to about 75 weight percent, and the balance of clay, wherein the weight percentages are determined on a dry solids basis and calculated as oxides.

18. The process of claim 1, wherein the zeolite comprises Y zeolite.

19. A fluidized catalytic cracking (FCC) catalyst formed by the process of claim 1.

20. A process for treating a hydrocarbon-containing feedstock comprising contacting the hydrocarbon-containing feedstock with a catalyst formed by the process of claim 1 to provide one or more treated hydrocarbon streams.
